(19) United States
(12) Patent Application Publication
(10) Pub. No.: US 2007/0125400 A1
(43) Pub. Date: Jun. 7, 2007

(54) In-line wafer cleaning system and method

(75) Inventor: Takayuki Matsui, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Elpida Memory, Inc., Tokyo (JP)

(21) Appl. No.: 11/634,085

(22) Filed: Dec. 6, 2006

(30) Foreign Application Priority Data
Dec. 7, 2005 (JP) 2005-353304

(51) Int. Cl. B08B 3/00; C23G 1/00

(52) U.S. Cl. 134/2; 134/94.1; 134/95.1; 134/26; 134/34

(57) ABSTRACT

A wafer cleaning system includes a wafer chuck for holding a wafer top side down and a stage having a top surface opposing the wafer. The top surface of the stage includes thereon a plurality of cleaning liquid nozzles, a plurality of rinsing liquid nozzles, a central drain funnel and a peripheral drain funnel. The cleaning liquid as well as the rinsing liquid is retained in the gap between the wafer surface and the stage by the surface tension of the liquid for effecting a retention cleaning treatment and a retention rinsing treatment.

### BACKGROUND OF THE INVENTION

(a) Field of the Invention

The present invention relates to in-line wafer cleaning system and method and, more particularly, to a system and a method for cleaning wafers in an in-line process.

(b) Description of the Related Art

A wafer cleaning process is used in a fabrication process of semiconductor devices for removing residuals attached onto a semiconductor wafer (referred to as merely wafer hereinafter) during a fabrication process thereof to prevent the residuals from contaminating the wafer or final products. Along with development of the fabrication process for manufacturing the semiconductor devices having a finer pattern, contamination of wafer by the residuals generated in the fabrication process has become a serious problem on the product yield of the semiconductor devices. Thus, the wafer cleaning process is highlighted more and more in the fabrication process. The wafer cleaning process generally includes consecutive steps of cleaning the wafer surface by using a cleaning liquid including chemicals, rinsing the wafer surface by using a rinsing liquid such as pure water, and drying the wafer surface to deliver the wafer to the next stage.

In these days, a variety of types of semiconductor devices are manufactured in accordance with a variety of specifications. This necessitated use of an in-line wafer cleaning process wherein the wafers are subjected to the cleaning process one by one. A wafer cleaning system using the in-line cleaning process is described in Patent Publication JP-2005-183937A, for example.

FIG. 9 shows the in-line wafer cleaning system described in the above publication. A wafer 41 to be cleaned by the cleaning system 40 is disposed on a wafer stage 42 which rotates around a vertical axis thereof. A cleaning liquid nozzle 43 ejecting a cleaning liquid and a rinsing liquid nozzle 44 ejecting a rinsing liquid are disposed above the wafer stage 42. In the cleaning step, the cleaning liquid is ejected from the cleaning liquid nozzle 43 onto the surface of the rotating wafer 41 at the central portion thereof to chemically remove residuals such as including resist from the wafer surface.

In the rinsing step, the rinsing liquid is ejected from the rinsing liquid nozzle 44 onto the surface of the rotating wafer 41 to rinse the cleaning liquid and residuals contained in the cleaning liquid from the wafer surface. In the drying step, the wafer 41 is rotated at a higher speed to scatter the rinsing liquid remaining on the wafer surface in the radially outward direction of the wafer 41 for drying.

The wafer cleaning system 40 described in the above publication provides the cleaning liquid and rinsing liquid onto the rotating wafer 41, wherein rotation of the wafer causes a charge up of the wafer 41, i.e., accumulation of electrostatic charge on the wafer 41. The electrostatic charge accumulated on the wafer 41 may cause a damage of the wafer 41 due to a discharge between the wafer surface and the cleaning liquid nozzle 43 or rinsing liquid nozzle 44. Thus, it is essential to prevent the damage of the wafer by suppressing the charge up of wafer during the wafer cleaning process, in order to maintain a higher product yield of the semiconductor devices.

### SUMMARY OF THE INVENTION

In view of the above problem in the conventional technique, it is an object of the present invention to provide a wafer cleaning process which is capable of suppressing the charge up of wafer during the wafer cleaning process.

It is another object of the present invention to provide a wafer cleaning system using such a wafer cleaning process.

The present invention provides a wafer cleaning system including: a wafer holder for holding a wafer in a posture parallel to a horizontal plane, and a stage having a stage surface opposing the wafer held by the wafer holder, the stage surface including thereon at least one of a cleaning liquid nozzle for supplying a cleaning liquid and a rinsing liquid nozzle for supplying a rinsing liquid.

The present invention also provides a method for cleaning a wafer by using a wafer cleaning system including a wafer holder for holding a wafer in a posture parallel to a horizontal plane, and a stage having a stage surface opposing the wafer held by the wafer holder, the stage surface including thereon at least one of a cleaning liquid nozzle for supplying a cleaning liquid and a rinsing liquid nozzle for supplying a rinsing liquid, the method including the step of: cleaning the wafer while retaining a cleaning liquid supplied through the cleaning liquid nozzle and/or a rinsing liquid supplied through the rinsing liquid nozzle in a gap between the stage surface and the wafer.

In accordance with the wafer cleaning system of the present invention, the cleaning liquid and/or rinsing liquid can be supplied onto the wafer without rotating the wafer, thereby preventing the charge up of the wafer.

In accordance with the wafer cleaning method of the present invention, retention of the cleaning liquid and/or rinsing liquid within the gap between the wafer and the stage surface saves the amount of the cleaning liquid and/or rinsing liquid consumed in the wafer cleaning process.

The above and other objects, features and advantages of the present invention will be more apparent from the following description, referring to the accompanying drawings.

### BRIEF DESCRIPTION OF THE DRAWINGS

FIG. 1 is a sectional view of a wafer cleaning system according to an embodiment of the present invention.

FIG. 2 is a top plan view of the wafer stage shown in FIG. 1.

FIGS. 3A to 3E are sectional views of the wafer cleaning system of FIG. 1 in consecutive steps of a wafer cleaning process according to an embodiment of the present invention.

FIGS. 4 to 8 are top plan views of wafer stages modified from the wafer stage of FIG. 2.

FIG. 9 is a sectional view of a conventional wafer cleaning system.

### PREFERRED EMBODIMENT OF THE INVENTION

Now, the present invention is more specifically described with reference to accompanying drawings, wherein similar constituent elements are designated by similar reference numerals.

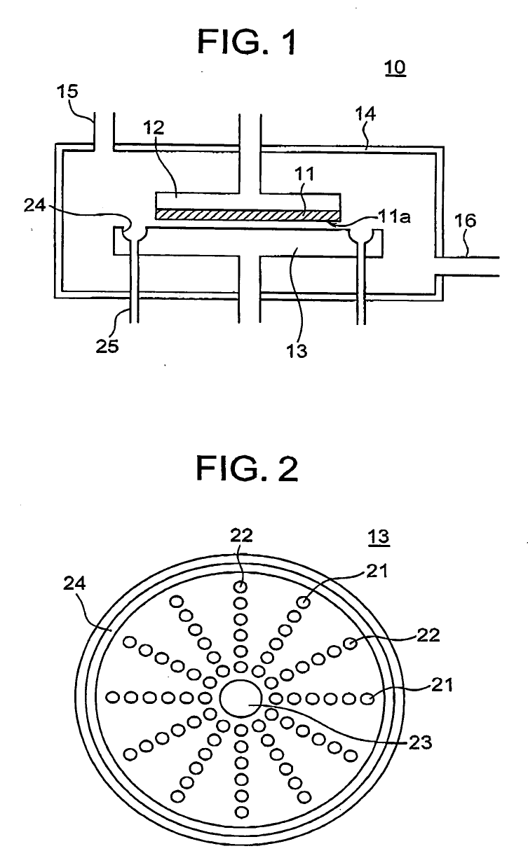

FIG. 1 shows a wafer cleaning system, generally designated by numeral 10, according to an embodiment of the present invention. The wafer cleaning system 10 is configured as an in-line wafer cleaning system, and includes a wafer holder or wafer chuck 12 movable in the vertical direction, while holding a wafer 11 with the main surface of the wafer 11 being directed downward, and a stage 13 having a top surface opposing the main surface of the wafer 11 for supplying a cleaning liquid and a rinsing liquid to the wafer 11.

The wafer chuck 12 attracts the rear surface of the wafer 11 by air suction or negative pressure to maintain the wafer in the posture parallel to a horizontal plane. The wafer chuck 12 moves in the vertical direction to transfer the wafer 11 with respect to the stage 13. The wafer chuck 12 and stage 13 are received within a chamber 14, which has a gas inlet port 15 at the top thereof and a gas outlet port 16 in the vicinity of the bottom thereof.

FIG. 2 shows the top surface of the stage 13 having a circular shape slightly larger than the circular shape of the wafer 11. The top surface of the stage 13 has thereon a plurality of cleaning liquid nozzles 21 arranged in a plurality of rows each extending in the radial direction, and a plurality of rinsing liquid nozzles 22 arranged in a plurality of rows each extending in the radial direction. The rows of the cleaning liquid nozzles 21 and the rows of the rinsing liquid nozzles 22 are disposed alternately with each other at a specific angular pitch as viewed from the center of the wafer 11 or stage 13.

The top surface of the stage 13 has thereon a central drain funnel 23 at the center thereof for discharging therethrough a waste liquid by air suction. The size of the cleaning liquid nozzles 21, rinsing liquid nozzles 22 and central drain funnel 23 is such that the size allows the cleaning liquid or rinsing liquid supplied onto the stage 13 to stay over the entire surface area of the stage 13 opposing the wafer 11 due to the surface tension of the liquid itself.

The peripheral portion of the stage 13, located outside the area of the wafer 11 as viewed in the vertical direction, is provided with an annular drain funnel 24 coupled to a drain tube 25 (FIG. 1) for discharging the waste liquid by gravity or air suction.

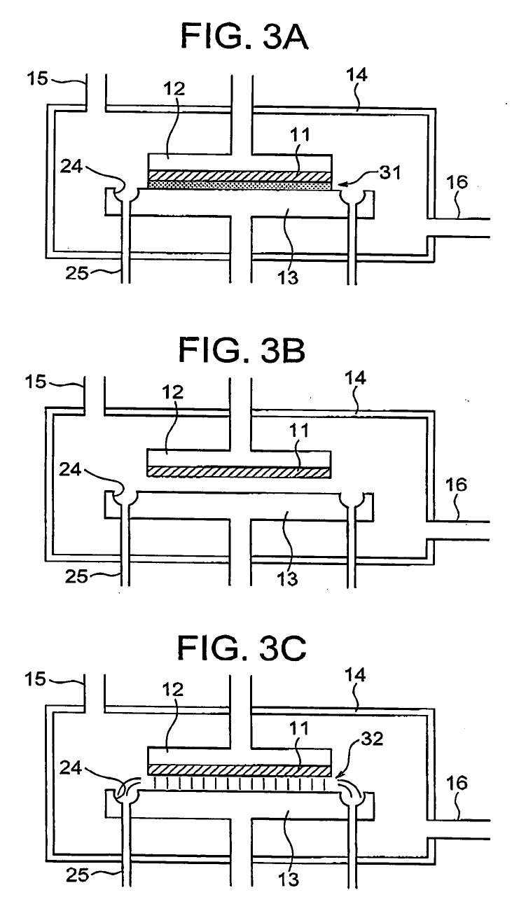

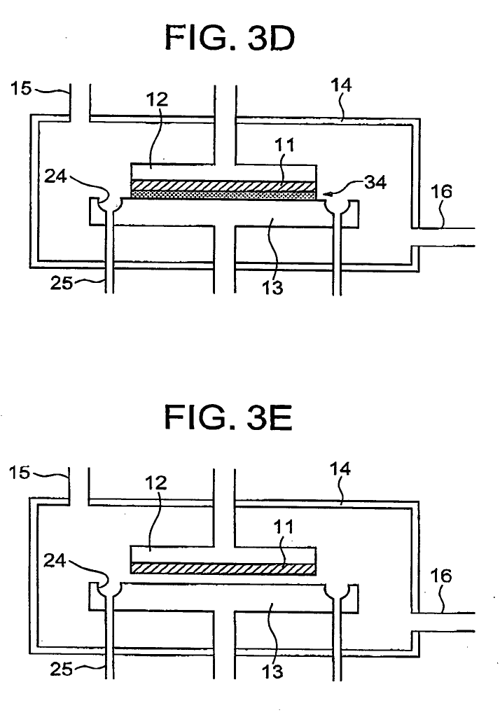

FIGS. 3A to 3E show consecutive steps of the wafer cleaning process used in the wafer cleaning system 10 of FIG. 1. A wafer 11 to be cleaned by the wafer cleaning system 10 is introduced in the chamber 14 and fixed onto the wafer chuck 12 by air suction, with the main surface of the wafer 11 being directed downward. The wafer chuck 12 is then moved downward and stopped at the location at which the main surface of the wafer 11 is several millimeters apart from the top surface of the stage 13. This step is depicted in FIG. 1. Subsequently, N₂ gas is introduced in the chamber 14 through the gas inlet port 15 while discharging the N₂ gas through the gas outlet port 16, whereby the internal of the chamber 14 is filled with the N₂ gas.

Thereafter, a cleaning step is started by ejecting the cleaning liquid through the cleaning liquid nozzles 21, thereby allowing the cleaning liquid to be retained within the gap between the wafer 11 and the stage 13, as shown in FIG. 3A. More specifically, the cleaning liquid 31 supplied to the gap between the wafer surface 11a and the stage 13 stays in the gap due to the surface tension thereof. This state of the cleaning liquid 31 is maintained for a specific time length for cleaning the wafer surface 11a, and this treatment is referred to as retention cleaning treatment in this text. After the retention cleaning treatment, the cleaning liquid 31 in the gap is discharged by air suction through the central drain funnel 23 and peripheral drain funnel 24. If desired, the retention cleaning treatment and discharge of the cleaning liquid may be iterated for several times by using a common cleaning liquid or different cleaning liquids.

Thereafter, the wafer chuck 12 is moved upward and stopped at the location at which the wafer surface 11a is several centimeters apart from the surface of the stage 13, as shown in FIG. 3B, thereby preparing for a rinsing step. The rinsing step is started by ejecting the rinsing liquid 32 upward in a shower fashion through the rinsing liquid nozzles 22, as shown in FIG. 3C. The shower ejection is performed for a specific time length to rinse the wafer surface 11a in a shower rinse treatment. The rinsing liquid may be pure water or a chemical liquid. In the shower rinse treatment, the waste liquid is drained through the annular drain funnel 24 and drain tube 25, as shown in FIG. 3C. The shower rinse treatment efficiently rinses the wafer surface 11a.

Subsequently, the wafer chuck 12 is moved downward and stopped at the location at which the wafer surface 11a is several millimeters apart from the stage 13. The rinsing liquid is supplied to the gap between the wafer surface 11a and the stage 13, and retained therein for a specific time length due to the surface tension of the rinsing liquid, thereby effecting a retention rinse treatment. After the retention rinse treatment, the rinsing liquid in the gap is discharged through the central drain funnel 23 and annular drain funnel 24.

After completion of the retention cleaning treatment shown in FIG. 3A or retention rinse treatment shown in FIG. 3D, the cleaning liquid or rinsing liquid staying in the gap can be efficiently discharged through the central drain funnel 23 by suction. This allows the subsequent step to be started quickly.

It is to be noted that droplets of the rinsing liquid, in particular, are likely to be left on the wafer surface 11a after the end of rinsing step in the conventional technique. The droplets on the wafer surface may be left in the subsequent drying step, to form a water mark on the wafer surface 11a after the drying step. In the present embodiment, however, the rinsing liquid is forcedly discharged through the drain funnel by suction, whereby the droplets are effectively removed from the wafer surface 11a to thereby suppress occurrence of the water mark.

In the present embodiment, the fact that the wafer chuck 12 holds the wafer at the rear surface of the wafer 11 by air suction suppresses attachment of the droplets of the cleaning liquid or rinsing liquid onto the wafer chuck 12. This allows the cleaning liquid or rinsing liquid to contact only the wafer surface 11a and the stage 13, thereby allowing the surface tension to efficiently act on the wafer surface 11a and the stage 13 and obtain a sufficient strength of the surface tension. In addition, a water mark on the wafer surface 11a, which may be formed by droplets of the rinsing liquid in the conventional technique, can be suppressed in the present embodiment.

In the subsequent drying step, as shown in FIG. 3E, discharge of gas through the gas outlet port 16 and air suction of the waste liquid through the central drain funnel 23 are continued from the preceding rinsing step for drying the wafer 11. After the end of drying step, the wafer 11 is taken out from the chamber 14.

In accordance with the wafer cleaning system and wafer cleaning process of the above embodiment, the wafer 11 is cleaned and rinsed in the cleaning step and the rinsing step, respectively, without rotation of the wafer 11. This suppresses occurrence of the charge up as encountered in the conventional wafer cleaning system, thereby preventing the electrostatic breakdown of the wafer. The shower rinse treatment effectively rinses the wafer surface 11a, whereas the retention rinse treatment saves the amount of consumed rinsing liquid.

In a modification of the wafer cleaning system of the above embodiment, the wafer chuck 12 has therein a heater for heating the wafer 11, to thereby render the cleaning step, rinsing step and drying step more efficient. This also saves the amount of consumed cleaning liquid.

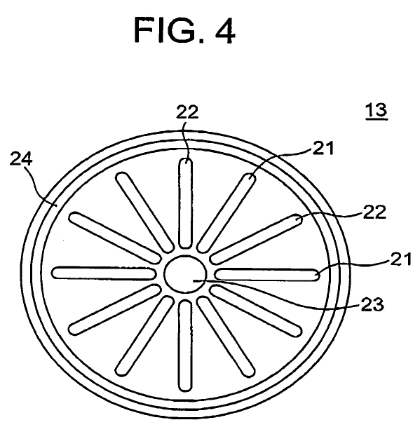

The shape or arrangement of the elements of the above embodiment, such as the cleaning liquid nozzles, rinsing liquid nozzles, drain funnels is not limited to the shape or arrangement exemplified in the drawings such as FIG. 2. FIGS. 4 to 8 exemplify top plan views of stages modified from the stage 13 of FIG. 2. In the stage 13 of FIG. 4, the cleaning liquid nozzles 21 and rinsing liquid nozzles 22 have an elongate shape extending in the radial direction of the wafer 13.

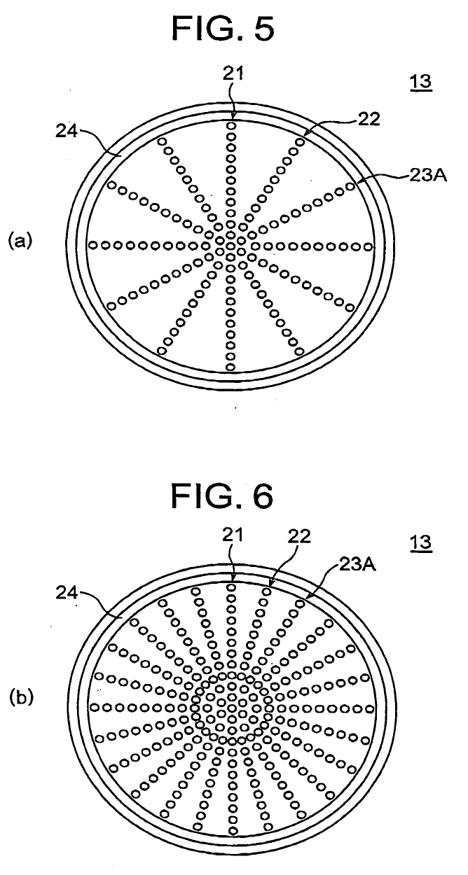

In the stages 13 shown in FIGS. 5 and 6, a plurality of drain ports 23A are provided instead of the central drain funnel 23, the drain ports 23A being arranged in a plurality of rows extending in the radial direction and arranged at a plurality of angular positions, similarly to the cleaning nozzles 21 and rinsing nozzles 22. These rows of the nozzles and ports 21, 22, 23A are arranged at an angular pitch of 30 degrees in the example of FIG. 5, whereas the rows of the nozzles and ports 21, 22, 23A are arranged at an angular pitch of 15 degrees in the example of FIG. 6.

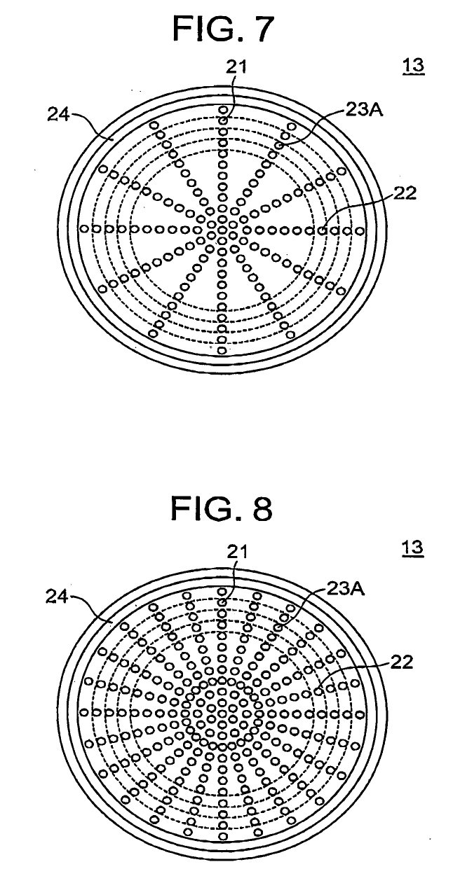

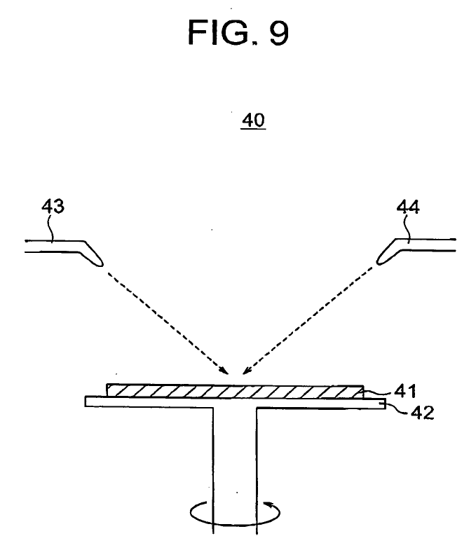

In the stages 13 shown in FIGS. 7 and 8, the drain ports 23A as well as the cleaning liquid nozzles 21 and rinsing liquid nozzles 22 in each of a plurality of groups are arranged in the circumferential direction of the stage 13, wherein the groups are arranged at respective radial positions and concentrically with one another group. The drain ports 23A in each group as well as the cleaning liquid nozzles 21 and rinsing liquid nozzles 22 in each group are arranged at an angular pitch of 30 degrees in the example of FIG. 7, whereas these ports or nozzles in each group are arranged at an angular pitch of 15 degrees in the example of FIG. 8.

As exemplified in FIGS. 5 to 8, these nozzles and ports 21, 22, 23A ejecting or discharging a specific liquid should be preferably disposed in a uniform arrangement, i.e., in a uniform number of the nozzles (ports) per unit area of the surface of the stage 13, although the arrangement of these nozzles (ports) is not limited to a specific location or order.

The uniform arrangement of the liquid nozzles 21 or 22, wherein the number of the liquid nozzles per unit area is uniform on the stage 13, allows the liquid ejected by the liquid nozzles to effectively stay in the gap between the wafer surface 11a and the stage 13 due to the surface tension, and allows the liquid in the gap to uniformly clean or rinse the wafer surface 11a. The uniform arrangement of the drain ports 23A allows the drain ports 23A to effectively discharge the liquid staying on the stage 13. At least some of the ports or nozzles may be used for a plurality of purposes, such as ejecting both the liquids or ejecting and discharging the same liquid, so long as the concentration of the liquids or liquid does not significantly affect the quality of the cleaning process.

In the wafer cleaning system including the stage 13 shown in FIG. 2, 4, 5 or 6, the wafer chuck 12 holding the wafer 11 may be swiveled within a specific angular range. The swivel movement of the wafer chuck 12 holding the wafer 11 allows the cleaning liquid or rinsing liquid to be efficiently supplied over the entire gap area between the wafer surface 11a and the stage 13.

In the wafer cleaning system including the stage 13 shown in FIG. 4, 5 or 6, the swivel movement of the wafer chuck 12 holding the wafer 11 allows the waste liquid on the stage 13 to be efficiently discharged. The specific angular range may be equal to the angular pitch of arrangement of the nozzles 21, 22 or ports 23A.

In the cleaning step of the wafer cleaning process of the above embodiment, a shower cleaning treatment may be added prior to the retention cleaning treatment by ejecting the cleaning liquid in a shower fashion through the cleaning liquid nozzles 21, thereby effectively cleaning the wafer 11.

In the shower cleaning treatment, the waste liquid is discharged through the central drain funnel 23 and the annular drain funnel 24, similarly to the shower rinsing treatment.

In the drying step, isopropyl-alcohol (IPA) or a gas thereof may be used by diluting the rinsing liquid with the IPA or IPA gas, for effectively drying the wafer. In the case of using the IPA, the IPA is ejected through the cleaning liquid nozzles 21 for retention in the gap between the wafer surface 11a and the stage 13, similarly to the retention cleaning treatment, followed by discharging the waste liquid through the central drain funnel 23 by suction. The IPA gas may be introduced through the gas inlet port 15.

Since the above embodiments are described only for examples, the present invention is not limited to the above embodiments and various modifications or alterations can be easily made therefrom by those skilled in the art without departing from the scope of the present invention.

What is claimed is:

1. A wafer cleaning system comprising:
a wafer holder for holding a wafer in a posture parallel to a horizontal plane, and
a stage having a stage surface opposing the wafer held by said wafer holder, said stage surface including thereon at least one of a cleaning liquid nozzle for supplying a cleaning liquid and a rinsing liquid nozzle for supplying a rinsing liquid.

2. The wafer cleaning system according to claim 1, wherein a plurality of said cleaning liquid nozzle and/or a plurality of said rinsing liquid nozzle are arranged on said stage surface.

3. The wafer cleaning system according to claim 2, wherein said plurality of said cleaning liquid nozzle and/or said plurality of said rinsing liquid nozzle are arranged in a radial direction of the wafer.

4. The wafer cleaning system according to claim 1, wherein a plurality of rows of a plurality of said cleaning nozzle and/or a plurality of rows of a plurality of said rinsing liquid nozzle arranged in radial directions are arranged at a specific angular pitch as viewed from a center of the wafer.

5. The wafer cleaning system according to claim 2, wherein said plurality of said cleaning liquid nozzle and/or said plurality of said rinsing liquid nozzle are arranged in a circumferential direction of the wafer.

6. The wafer cleaning system according to claim 1, wherein a plurality of groups of a plurality of said cleaning liquid nozzle and/or a plurality of groups of a plurality of said rinsing liquid nozzle arranged in a circumferential direction are arranged concentrically with one another group.

7. The wafer cleaning system according to claim 1, wherein said stage surface further includes thereon drain funnel for discharging said cleaning liquid and/or rinsing liquid.

8. The wafer cleaning system according to claim 2, wherein said stage surface includes thereon a plurality of drain ports.

9. The wafer cleaning system according to claim 1, wherein said holder includes therein a heater for heating the wafer held on said holder.

10. The wafer cleaning system according to claim 1, wherein said holder is movable with respect to said wafer stage to a location such that a gap between the wafer and said stage surface retains said cleaning liquid and/or said rinsing liquid by a surface tension thereof.

11. A method for cleaning a wafer by using a wafer cleaning system including a wafer holder for holding a wafer in a posture parallel to a horizontal plane, and a stage having a stage surface opposing the wafer held by said wafer holder, said stage surface including thereon at least one of a cleaning liquid nozzle for supplying a cleaning liquid and a rinsing liquid nozzle for supplying a rinsing liquid, said method comprising the step of:
cleaning the wafer while retaining a cleaning liquid supplied through said cleaning liquid nozzle and/or a rinsing liquid supplied through said rinsing liquid nozzle in a gap between said stage surface and the wafer.
